(19) United States
(12) Patent Application Publication
(10) Pub. No.: US 2025/0128211 A1
(43) Pub. Date: Apr. 24, 2025

(54) Harnessing Metal Ions from Brines

(71) Applicant: Massachusetts Institute of Technology, Cambrdige, MA (US)

(72) Inventors: John H. Lienhard, Lexington, MA (US); Andrew Bouma, Cambridge, MA (US); Danyal Rehman, Cambridge, MA (US); Zi Hao Foo, Somerville, MA (US)

(21) Appl. No.: 18/686,547

(22) PCT Filed: Aug. 26, 2022
(86) PCT No.: PCT/US2022/041614

§ 371 Date: Feb. 26, 2024

Related U.S. Application Data
(60) Provisional application No. 63/237,279, filed on Aug. 26, 2021.

(51) Int. Cl. B01D 61/58; B01D 61/00; B01D 61/02; B01D 61/44; C01D 15/02; C02F 1/44; C02F 1/469; C02F 9/00; C02F 101/10; C22B 3/22; C22B 3/42; C22B 3/44; C22B 26/12; C22B 26/22

(52) U.S. Cl. CPC B01D 61/58; C01D 15/02; C02F 9/00; C22B 3/22; C22B 3/42; C22B 3/44; C22B 26/12; C22B 26/22; B01D 61/002; B01D 61/025; B01D 61/445; C02F 1/441; C02F 1/445; C02F 1/4695; C02F 2101/10

(57) ABSTRACT

Targeted metal ions can be harnessed from brines by feeding a mixed, aqueous, brine stream including the targeted metal ions and other dissolved ions through a water-recovery module on a first side of a first membrane. In the water-recovery module, water is passed from a monovalent-ion-rich stream on a second side of the first membrane through the first membrane into the mixed, aqueous, brine stream on the first side of the first membrane to produce a diluted, mixed, aqueous, brine stream. The diluted, mixed, aqueous, brine stream is then passed through a valency-selective ion-separation module to produce the monovalent-rich stream, and a multivalent-ion-rich stream, one of which includes a concentration of the targeted metal ions.

### BACKGROUND

The discussion of the background state of the art, below, may reflect hindsight gained from the disclosed invention(s); and these characterizations are not necessarily admitted to be prior art.

Recovering lithium, either from spodumene deposits, or from salt-lake brines, has been an endeavor of increasing prominence in recent times. With the demand of lithium on the rise for battery manufacturing, solutions that can recover lithium at a low energy expense, while ensuring high yield, are heavily sought after. State-of-the-art solutions employ solar ponds to concentrate brines, which require the acquisition of expensive land area and are difficult to regulate given their dependence on the weather.

### SUMMARY

A method for harnessing targeted metal ions, such as lithium, from brines and a system therefor are described herein, where various embodiments of the methods and systems may include some or all of the elements, features and steps described below.

Using a system, described herein, targeted metal ions can be harnessed from brines by feeding a mixed, aqueous, brine stream including the targeted metal ions and other dissolved ions through a water-recovery module on a first side of a first membrane. In the water-recovery module, water is passed from a monovalent-ion-rich stream on a second side of the first membrane through the first membrane into the mixed, aqueous, brine stream on the first side of the first membrane to produce a diluted, mixed, aqueous, brine stream. The diluted, mixed, aqueous, brine stream is then passed through a valency-selective ion-separation module to produce the monovalent-rich stream, and a multivalent-ion-rich stream, one of which includes a concentration of the targeted metal ions.

The systems proposed here exploit a series of membrane-based separation technologies to selectively separate and concentrate lithium from brines (e.g., hypersaline brines). The reported systems rely on a combination of pressure-based and electrochemical-based technologies to produce industry-grade lithium for practical consumption. The process and its viability are discussed in more detail below with a case study for two different operating modes and a given configuration. Additional configurations are included in the final section.

### BRIEF DESCRIPTION OF THE DRAWINGS

FIG. 1 schematically illustrates a configuration of unit operations to recover lithium from brines.

FIG. 2 is a plot of permselectivity in brackish water range for both NEOSEPTA ion-exchange membranes and FUJIFILM ion-exchange membranes.

FIG. 3 schematically illustrates a second exemplary system for recovering lithium from a brine.

FIG. 4 schematically illustrates a third exemplary system for recovering lithium from a brine.

FIG. 5 schematically illustrates a fourth exemplary system for recovering lithium from a brine.

FIG. 6 schematically illustrates a fifth exemplary system for recovering lithium from a brine.

FIG. 7 schematically illustrates a sixth exemplary system for recovering lithium from a brine.

FIG. 8 schematically illustrates the flows through a pressure retarded osmosis (module).

FIG. 9 schematically illustrates a generalized system, showing the substitutability of the forward and pressure-retarded osmosis modules, the substitutability of the valency-selective electrodialysis module and the nanofiltration module, and the substitutability of the osmotically assisted reverse osmosis module and low-salt-rejection modules in systems described herein (such as the systems shown in FIGS. 6 and 7) that include either of these modules.

FIG. 10 schematically illustrates another generalized system, showing the substitutability of components in systems described herein, such as in the systems shown in FIGS. 4 and 5.

FIG. 11 schematically illustrates a system for lithium extraction, including a sequence of counterflow reverse-osmosis modules, a nanofiltration module, and a lithium-selective electrodialysis module.

FIG. 12 schematically illustrates another system for lithium extraction, similar to that of FIG. 11, but with a monovalent selective electrodialysis module in place of the nanofiltration module used in the system of FIG. 11.

FIG. 13 schematically illustrates another system for lithium extraction, this one using a single counterflow reverse-osmosis module, a nanofiltration module, and an ion-exchange resin that separates the diluted monovalent-rich stream from the nanofiltration module into a concentrated lithium-rich stream and a concentrated sodium-rich stream.

FIG. 14 schematically illustrates another system for lithium extraction, similar to that of FIG. 13, but with a valency-selective electrodialysis module in place of the nanofiltration module used in the system of FIG. 13.

FIG. 15 schematically illustrates another system for lithium extraction, similar to the system of FIG. 13 but with an ion sieve in place of the ion-exchange resin of FIG. 13.

FIG. 16 schematically illustrates another system for lithium extraction, similar to the system of FIG. 14 but with an ion sieve in place of the ion-exchange resin of FIG. 14.

FIG. 17 schematically illustrates another system for lithium extraction, similar to the system of FIGS. 13 and 15 but with a bipolar membrane electrodialysis module in place of the ion-exchange resin/ion sieve of FIGS. 13 and 15.

FIG. 18 schematically illustrates another system for lithium extraction, similar to the system of FIGS. 14 and 16 but with a bipolar membrane electrodialysis module in place of the ion-exchange resin/ion sieve of FIGS. 14 and 16.

FIG. 19 includes plots of the separation factor achieved at different feed concentrations using a membrane from NEOSEPTA ion-exchange membrane versus using a FUJIFILM ion-exchange membrane in a valency-selective electrodialysis module used in a system utilizing valency-selective electrodialysis as a unit operation.

FIG. 20 includes plots of the separation factor achieved at different feed concentrations at two different pH levels—i.e., at a pH of 2 and at a PH of 7—for any system that utilizes nanofiltration as a unit operation.

In the accompanying drawings, like reference characters refer to the same or similar parts throughout the different views; and apostrophes are used to differentiate multiple instances of the same item or different embodiments of items sharing the same reference numeral. The drawings are not necessarily to scale; instead, an emphasis is placed upon illustrating particular principles in the exemplifications discussed below. For any drawings that include text (words, reference characters, and/or numbers), alternative versions of the drawings without the text are to be understood as being part of this disclosure; and formal replacement drawings without such text may be substituted therefor.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly. The term, “about,” can mean within +10% of the value recited. In addition, where a range of values is provided, each subrange and each individual value between the upper and lower ends of the range is contemplated and therefore disclosed.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as those introduced with the articles, “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video or audio form) for assembly and/or modification by a customer to produce a finished product.

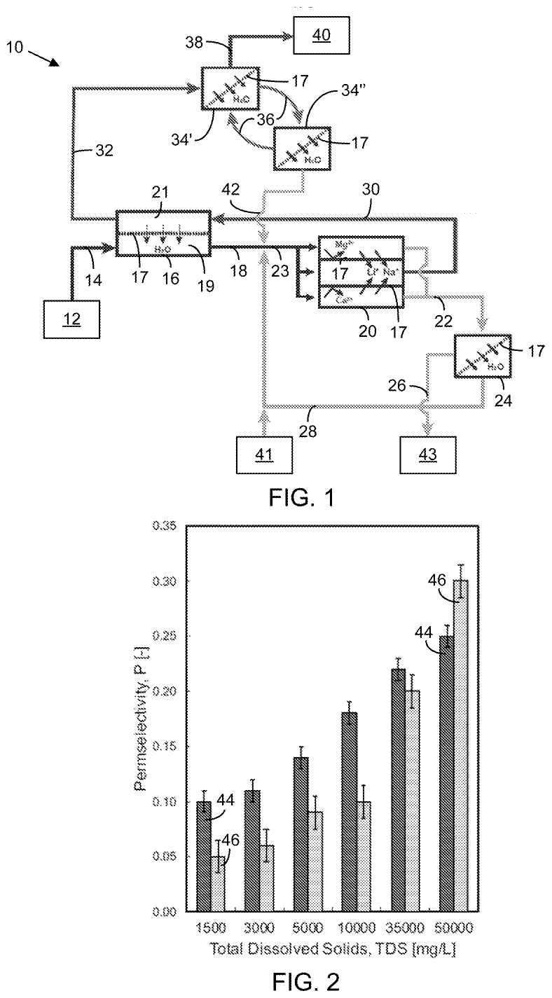

An exemplary system 10 for extracting lithium and/or other targeted monovalent ions, such as potassium and/or nitrate, from brine is shown in FIG. 1. Both proposed operating modes are designed to function using a wide array of brine compositions that are detailed in further sections. First, in this exemplification, hypersaline aqueous brine from a feed source 12 flows through a conduit 14 into a forward osmosis (FO) module 16 on a first side 19 of a semipermeable membrane 17. Here, the hypersaline brine acts as the draw solution, while a lower salinity, monovalent-ion-rich solution flows through a second side 21 of the semipermeable membrane 17 opposite from the hypersaline aqueous brine. The FO module 16 can operate in a parallel flow or counter-flow configuration; for increased system energetic performance, counter-flow may be a particularly advantageous mode of operation. Passing through the forward osmosis module 16, the water from the monovalent-ion-rich stream is drawn from the second side 21 of the membrane 17 into the hypersaline feed stream on the first side 19. This dilutes the hypersaline brine as water is transported through the membrane 17, while ion transport is inhibited. An alternative technology that can potentially meet the same requirement and recover energy is pressure-retarded osmosis (PRO) or reverse electrodialysis (RED). Direct dilution can also be used to achieve the desired dilution factor, which would be energetically inferior but may offer cost benefits.

The use of a PRO module 58 to dilute the incoming brine stream is described, below, and illustrated in FIG. 8. Energy recovery from the spontaneous mixing between two streams of different salinities can be achieved using pressure-retarded osmosis (PRO). The incoming feed stream, which is usually brine at higher salinity, flows through conduit 14 into the PRO module 58 as the top stream, as shown in FIG. 8, is first pressurized by a pump 56 to a higher pressure (from P₁ to P₂). After which, the pressurized feed flows through conduit 62 into the draw side of the PRO module 58 (usually hollow fiber), and spontaneous forward osmosis with a dilute stream 66 occurs. Water selectively permeates from the dilute stream through the membrane 17 and dilutes the brine feed stream, while the dilute stream gets concentrated by virtue of mass conservation. After exiting the PRO membrane module 58, the diluted brine stream flows through a conduit 64 to then be depressurized by a power-generating turbine 60 before exiting through conduit 68. The net work output from the turbine-pump assembly allows for power generation in the form of electricity, allowing for effective energy recovery from dilution. A dilute stream is fed via conduit 66 through the bottom side of the PRO module 58 on the opposite side of the membrane 17 from the feed stream.

The work presented below uses forward osmosis (FO) for the case study. The incoming stream to the FO module has now significantly dropped in concentration; this generates a far less concentrated brine solution as the product. This product stream, however, is still rich in the lithium ions initially present in the hypersaline feed. This water-recovery phase can be designed to tailor the feed for optimal performance of the following selective stage.

In this exemplification, as shown in FIG. 1, a valency-selective electrodialysis (MSED) system 20 functions as the selective stage and follows the initial FO module 16 with conduits 18 and 23 providing passage for the feed liquid to flow therebetween. Both the FO module 16 and valency-selective electrodialysis module 20 selectively separate the feed liquid using membranes 17. MSED has previously shown efficient selectivity at low-concentration feeds, with worsened performance at elevated feed salinities. Studies in the Lienhard Research Group at Massachusetts Institute of Technology, including inventors named herein, have illustrated that, at brackish water salinities, up to 90% of sodium can be removed from the incoming source water, while up to 90% of the incoming magnesium can be retained in the final product [see Y. Ahdab, et al., “Brackish water desalination for greenhouses: improving groundwater quality for irrigation using monovalent selective electrodialysis reversal,” Journal of Membrane Science 610:118072 (2020) and D. Rehman, et al., “Monovalent selective electrodialysis: Modelling multi-ionic transport across selective membranes,” Water Research 199:117171 (2021)]. These same selectivities drop from a 9:1 ratio to 4:1 in the seawater range, at concentrations around 35 g/kg. This reduced performance at elevated salinities makes use of the upstream water-recovery module advantageous. After brine dilution in the forward osmosis module 16, the conduit section 18 for the product stream reaches a junction for receiving potable water from conduits 28 and 42; and flow then continues through conduit section 23, which splits the flow prior to entry into the selective MSED separation stage 20. Instead of an MSED system 20 for selective treatment of the monovalent-ion-rich stream, a nanofiltration (NF) system 50, as shown in FIG. 4, can alternatively be employed. Nanofiltration usually provides competitive energetic characteristics to MSED.

It may also be possible to bring down the brine concentration to seawater salinities and then use nanofiltration for the selective ion-ion separation. This use may yield less exergy destruction with potentially better energetics and a capacity for low-pressure operation.

If MSED is adopted as the selective stage, the split ratio of the product stream into the module is variable, and is a function of both the yield and energy consumption. The ratio is a design variable that can be optimized for a given feed salinity and composition.

The MSED stack can be equipped with a series of monovalent-selective cation-exchange membranes and monovalent-selective anion-exchange membranes. One pair of each ion-exchange membrane 17 constitutes a cell pair, while the entire stack can comprise 20 or fewer cell pairs for lab-scale demonstration units, and up to, including, or even over 1,000 cell pairs for commercial-scale units. The ion-exchange membranes 27 enables preferential passage of monovalent ions, while retaining multivalent ions. The product of the separation is a stream rich in monovalent ions (through conduit 30) and a stream rich in multivalent ions (through conduit 22). The multivalent-rich stream from conduit 22 can be used for a number of purposes, including but not limited to agricultural use, sourcewater for freshwater production, or feed solution for the FO module 16. The latter approach is observed in FIG. 1, where the multivalent-rich stream is first passed through an RO module 24 before then passing through conduit 28 back to the juncture where this flow joins that from counduit 18 en route to the MSED module 20. The RO module 24 generates, on its retentate side a multi-valent rich stream that is extracted through conduit 26 and delivered to reservoir 43; from its permeate side, the RO module generates potable water, which is extracted through conduit 28. The amount of additional water needed for both operating modes has been evaluated and is detailed further in the case study. One mode may be more valuable than the other depending on the relative costs between purchasing water and energy. In both cases, however, the multivalent ions present in the flow may also be valorized, depending on the value of the products at the location of interest. If recapturing the value of compositions is not feasible, the products may alternatively be disposed of.

The monovalent stream on conduit 30, now rich in lithium (among other monovalent cation species that may include sodium and potassium) can proceed to be concentrated. The concentration stage, in the form of a reverse-osmosis module 24 in this embodiment, follows the selective-separation stage 20 to generate an acceptable concentration of lithium for the following precipitation reactions that prepare the lithium to reach the appropriate standards for practical applications. Lithium is commonly needed as a carbonate or as a hydroxide when used as a feedstock for battery manufacturing, which can be achieved through carbonate displacement precipitation reactions using sodium carbonate. The present work does not assess or evaluate the precipitation reactions needed to obtain pure lithium; this step is consistent across standard methods in the literature and would remain unchanged in the proposed extraction methodology. Innovations here arise in the water recovery, selective separation, and concentration processes described herein.

The concentration stage 24 can be split into two components. The first component is the reuse of the monovalent-ion-rich product stream from the selective stage 20 as the draw solution through the draw side 21 of the FO module 16. As the concentration of this stream is low relative to the initial hypersaline brine flowing through the FO module 16 on the opposite side 19 of the membrane 17, a spontaneous process through the FO module 16 concentrates the lithium without the need for additional work. As alluded to previously, the high rejection of FO membranes causes only water to permeate the membrane 17. The exiting stream flowing through conduit 32 is now rich in monovalent ions, and contains significantly less water. The resulting highly concentrated monovalent-ion-rich stream in conduit 32 can now undergo additional concentrating to reach the required concentrations for industry use.

After using the FO module 16 to concentrate the monovalent-ion-rich stream from conduit 30, a secondary concentration module is used. The secondary concentration module can perform a thermal process, such as multiple effect distillation (MED), mechanical vapour compression (MVC), use of evaporation ponds, solvent-based concentration processes, or membrane-based processes, such as osmotically assisted reverse osmosis (OARO), solvent-based concentration processes, or ultra-high-pressure RO hybridized with another brine-concentration technology. In other exemplifications, the secondary concentration module can perform bipolar membrane electrodialysis, direct distillation, or multi-stage flash distillation. Membrane-based processes have generally shown better energetic performance in concentrating brines; consequently, OARO is the subject of study in the concentration stage. OARO goes by many names in the literature: counter-flow reverse osmosis (CFRO) and cascading osmotically mediated reverse osmosis (COMRO), among others. OARO is a relatively new and up-and-coming technology with the ability to concentrate hypersaline brines, a feature that conventional RO fails to achieve. In other exemplifications, low-salt-rejection reverse osmosis (LSSRO) can be used.

Given that the monovalent-ion-rich stream exiting the second side 21 of the forward osmosis module 16 through counduit 32 will have a concentration well above that of traditional seawater brine (near 70 g/kg), OARO can serve as an effective water treatment solution. The OARO system receives the flow from conduit 32 and can comprise at least two counter-flow RO modules 34′ and 34″, as shown in FIG. 1. The product stream of the first RO module 34′ is circulated through conduits 36 and used as a sweep stream for the second RO module 34″, and this cycling process yields an energetically efficient concentration process, wherein the monovalent-rich brine product is fed from the retentate side of the first RO module 34′ through conduit 38 to a monovalent brine reservoir 40. Results from the Lienhard Research Group, including inventors named herein (see A. T. Bouma and J. H. Lienhard V, “Split-feed counterflow reverse osmosis for brine concentration,” Desalination, online 27 Aug. 2018, 445:280-291, 1 Nov. 2018), have indicated that a six-stage OARO system can concentrate seawater upto 200 g/kg at a recovery ratio of 81% and require as little as 3.9 kWh/m³ of electricity. An equivalent MVC system consumes upward of 14 kWh/m³ of electricity. Meanwhile, the permeate from the second (or last) RO module 34″ is fed through conduit 42 from the permeate side of that RO module 34″ back into a juncture where it joins the flow from conduit 18 from the FO module 16.

When combining these systems in this particular configuration and leveraging the key capabilities of each technology, the proposed system is able to deliver a lithium-rich product stream from the OARO system that is ready for precipitation reactions, and consequently industry-standard use. The energetics of each individual stage and predicted yields are delineated below through a case study.

We further note that practical considerations may render advantageous the use of alternative brine concentration technologies, such as MVC, MED, solar evaporation, bipolar membrane electrodialysis, direct distillation, or multi-stage flash distillation.

### Operating Parameters and Analysis:

The mixed, aqueous brine stream (from reservoir 12, which can be a manufactured vessel or a naturally existing source) can be from a spodumene deposit or a salt lake or can be a geothermal leachate, a continental brine (i.e., a brine found in an underground reservoir—in particular, for example, in Argentina, Bolivia and Chile—and typically pumped up into solar ponds for concentration), a textile-mill waste, a brine from the extraction of oil and/or gas, and a mining brine.

The case study explores a brine salinity of 200 g/kg, and a composition that comprises 90% sodium and 10% magnesium by moles (for the cations). The behaviour of lithium is expected to be similar to that of sodium as a result of its electronic valence. The models currently established in the group have characterized the system for sodium and are currently being extended to account for lithium. In addition, Table 1 below represents the distribution of brine compositions (expressed in g/kg) observed across the world. The salinity and composition simulated across all tests is informed by the data presented in this table. Lastly, the flow rate chosen for this trial case is 1 L/s with a total of 1 m³ of brine being input into the system. Tables 2 and 3 summarize the operating parameters for operating modes one and two, respectively.

TABLE 1
Brine compositions across lithium-rich salt lakes across the world

| Location | Na⁺ | Li⁺ | K⁺ | Ca²⁺ | Mg²⁺ | Cl⁻ | SO₄²⁻ |
|---|---|---|---|---|---|---|---|
| Salar de Atacama, Chile | 91.0 | 1.57 | 23.6 | 0.45 | 9.65 | 189.5 | 15.9 |
| Salar del Hombre Muerto, | 103.0 | 0.90 | 9.7 | 1.21 | 1.41 | 168.0 | 11.4 |
| Argentina | | | | | | | |
| Salar de Coipasa, Bolivia | 75.1 | 0.35 | 11.0 | 0.16 | 13.6 | 151.0 | 24.6 |
| Salar de Uyuni, Bolivia | 87.2 | 0.30 | 7.2 | 0.50 | 6.5 | 157.1 | 8.5 |
| Salar del Rincón, Argentina | 97.9 | 0.30 | 6.6 | 0.60 | 3.0 | 158.0 | 0 |
| Salar de Cauchari-Olaroz, | 93.3 | 0.51 | 4.2 | 0.33 | 1.45 | 148.6 | 15.7 |
| Argentina | | | | | | | |
| Da Qaidam Lake, China | 56.3 | 0.31 | 4.4 | 0.20 | 20.20 | 134.2 | 34.1 |
| Clayton Valley Salt Basin, | 63.7 | 0.23 | 8.0 | 0.45 | 0.36 | 100.0 | 6.6 |
| USA | | | | | | | |

In the case study, the first stage is the forward osmosis (FO) module 16. The FO module 16 exploits a spontaneous process and, consequently, does not require any energy input. Circulation pumps are needed to control operating flow rates. For sufficient dilution of the hypersaline source water, the use of two cross-flow FO modules 16 can be advantageous. In this case, 1,200 m² of membrane area is used. In characterizing FO membranes, the key operating parameters are: A, B, and S. A is the water permeability; B is the salt permeability; and S is the structural parameter. Typical values of A, B, and S for FO membranes are 2 LMH/bar, 0.5 LMH, and 600 μm, respectively. Here, LMH denotes litres per meter squared per hour. In this arrangement, for an incoming brine of 200 g/kg, we are able to reach a dilution factor of nearly 3 to near 70 g/kg, equivalent to that of seawater RO brine. Due to the dilution, the new flow rate can be determined by integrating the flux across the membrane area and adding it to the initial flow rate. This calculation yields a product flow rate of nearly 2.8 L/s. These numbers are obtained using cascaded 1D numerical models for the FO process that have been studied and validated against previous literature.

The exit stream entering conduit 18 from the FO module 16, now at a salinity of 70 g/kg and a flow rate of 2.8 L/s (with the same ratio of monovalent ions and multivalent ions as the source brine) blends with freshwater (potable water) from the RO module 24 and from the OARO modules 34′ and 34″. The freshwater can also or alternatively purchased and fed into the system from a reservoir 41. The recovered freshwater numbers are explored later in the text. To bring down the concentration to brackish water salinities, a flow rate of 17.2 L/s is employed from either of these sources in the first operating mode. For the second operating mode, the flow rate from the source is closer to 7.2 L/s. This lower flow rate from the source reduces the dilution and results in a higher salinity flow entering the valency-selective electrodialysis module 20; however, this flow rate can be a variable for energetic and yield optimization. For the first and second mode of operation, the total flow rate is maintained at 20 L/s and 10 L/s, respectively.

In both operating modes, the flow rates are split into one stream (i.e., the outer stream) for the diluate and one stream (i.e., the center stream) for the concentrate in the valency-selective electrodialysis module 20. A ¼-¾ split is prescribed for the monovalent-multivalent streams, respectively, for the first case. A ½-½ split is proposed for the second case. This ratio may also be a design variable to be quantified for optimal energy consumption and/or yield. In the first mode, as a result of the increased dilution ratio, the energy consumption expected of the valency-selective electrodialysis module 20 is nearly 2 kWh/m³ of feed solution. For the 20 L/s passed into the system (and 1 m³ of brine input), this constitutes a total energy consumption of 40 kWh. These numbers are obtained through experimentally validated 1D transport models developed in the Lienhard Research Group [D. Rehman, et al., “Monovalent selective electrodialysis: Modelling multi-ionic transport across selective membranes,” Water Research 199:117171 (2021)].

Similarly, for the second mode of operation, the lower dilution ratio leads to worsened selectivity and an increased specific energy consumption but a reduced dependence on external water supply. In this scenario, the models predict a specific energy consumption of 3.5 kWh/m³ of feed solution. For a reduced system flow rate of 10 L/s, this constitutes a total energy consumption of 35 kWh, in contrast to 40 kWh with the first mode.

For MSED system characterization, transport numbers are the governing operating parameters. Transport numbers, defined as TOP, determine the impact of the applied electric field on the transport of a particular ion species, j. Values for sodium and magnesium in the brackish range are 0.48 and 0.05, respectively. A conservative value of 0.4 was used for lithium across all modelling studies conducted.

Assuming these parameters and system performance characteristics, the monovalent-rich stream exiting the valency-selective electrodialysis module 20 is at a total dissolved solids (TDS) content of 36.8 g/kg (i.e., 36.8 grams of total dissolved solids per kilogram of liquid solvent) and a flow rate of 5 L/s in operating mode one. Similarly, for the second operating mode, the monovalent-ion-rich stream is at a TDS of 38 g/kg at the same flow rate. In both cases, this stream serves as the feed solution for the FO module 16; and its solids concentration increases as it passes through the second side 21 of the FO module 16.

Using the same A, B, and S parameters stated previously, the FO module generates a product draw stream with a TDS of 58 g/kg for both configurations. In addition, the flow rates are also conserved at 3.2 L/s for both modes. This equivalency is attributed to the same flow rate and concentration of feed being passed into the FO module in both trial scenarios (approximately).

The multivalent stream exiting the valency-selective electrodialysis module 20 through conduit 22 is a brackish water stream in both modes of operation. Consequently, the multivalent stream can be used to generate freshwater using an RO stage 24 that recycles water and reduces dependence on external sources. In the first scenario, the concentration is around 1 g/kg, while the second operating mode yields a salinity of 2 g/kg. For the same flow rate of 5 L/s, and a 90%-recovery-ratio RO system, freshwater can be produced in both cases and used to dilute the FO product stream, as previously stated. Under these conditions, the RO module 24 operates at a specific energy consumption of 0.6 kWh/m³ of product solution for a feed salinity of 1 g/kg, and 1 kWh/m³ for a feed salinity of 2 g/kg. Consequently, the second mode of operation requires less energy overall as less water is produced albeit at a higher specific energy consumption. This provides a flow rate of 13.5 L/s and 4.5 L/s of freshwater in the first and second cases, respectively.

In various exemplifications, any of the following types of RO modules can be configured and used to extract purified water from the multivalent-ion-rich stream: a stand-alone continuous or batch reverse osmosis module, a high-pressure reverse osmosis module, an osmotically assisted reverse osmosis module, a low-salt-rejection reverse osmosis module, an osmotically enhanced reverse osmosis module, a cascading osmotically mediated reverse osmosis module, and a counter-flow reverse-osmosis module.

The last part of the lithium-extraction process is the concentration stage using OARO modules 34′ and 34″ (alternatively, another secondary concentration technique can be used) and is identical for both operating modes. As the concentration and flow rates in the exit stream (in conduit 32) from the FO module 16 are essentially the same for both cases, the same calculations apply to both setups. For an inlet salinity of approximately 58 g/kg and flow rate of 3.2 L/s, a six-stage OARO module can be employed to step up the concentration to 200 g/kg. For OARO systems, the same characterization metrics are required for the membranes: A, B, and S. For the calculations conducted here, the A, B, and S values used corresponded to those used for single-salt NaCl studies performed by Gradiant Corporation: A=2.49 LMH/bar, B=0.39 LMH, and S=564 μm [C. Z. Liang, et al., “Ultra-strong polymeric hollow fiber membranes for saline dewatering and desalination,” Nature Communications 12:2338 (2021)]. These values aren't expected to deviate too significantly when lithium ions are present in the solution.

To reach these recovery ratios, the OARO system is expected to perform at 3.9 kWh/m³ of product solution, which would generate a brine stream of 200 g/kg at 0.9 L/s, with a fresh-water stream at 2.3 L/s. At these specific energy-consumption values, to generate the 2.3 L/s of product freshwater, 8.8 kWh is expected to be needed for both modes of operation.

In summary, the total energy requirement for operating mode one and two is approximately 57.1 and 43.5 kWh for 1 m³ of brine input, respectively. In addition, the total amount of external freshwater needed is 1.4 L/s and 0.4 L/s for operating mode one and two, respectively. Although the energy and freshwater requirements are lower for the second case, the expected yield is also lower. In the final 200 g/kg generated of monovalent-rich solution, around 30% less lithium is expected. These yield values are based on selectivity characterization studies conducted on the lab-scale in the Lienhard Research Group (see FIG. 2 for details).

FIG. 2 is a plot of permselectivity in brackish water range for both NEOSEPTA ion-exchange membranes 44 (from ASTOM Corporation of Tokyo, Japan) and FUJIFILM ion-exchange membranes 46 (from Fujifilm Manufacturing Europe B.V. of Tilburg, The Netherlands).

### Summary of Case Study Parameters:

For the first configuration and both operating modes, the volumetric flow rates and stream salinities are summarized in Tables 2 and 3, below.

TABLE 2
Operating Mode 1: Increased dilution factor

| Stream | | |
|---|---|---|
| Conduit | Volumetric Flow Rate (L/s) | Total Dissolved Solids (g/kg) |
| 14 | 1.0 | 200 |
| 18 | 2.8 | 70 |
| 23 | 20.0 | 10 |
| 30 | 5.0 | 36 |
| 32 | 3.2 | 58 |
| 38 | 0.9 | 200 |
| 22 | 15.0 | 1 |
| 26 | 1.5 | 10 |
| 42 | 2.3 | 0 |
| 28 | 13.5 | 0 |
| 29 | 1.4 | 0 |

TABLE 3
Operating Mode 2: Reduced dilution factor

| Stream | | |
|---|---|---|
| Conduit | Volumetric Flow Rate (L/s) | Total Dissolved Solids (g/kg) |
| 41 | 1.0 | 200 |
| 18 | 2.8 | 70 |
| 23 | 10.0 | 20 |
| 30 | 5.0 | 38 |
| 32 | 3.2 | 58 |
| 38 | 0.9 | 200 |
| 22 | 5.0 | 2 |
| 26 | 0.5 | 20 |
| 42 | 2.3 | 0 |
| 28 | 4.5 | 0 |
| 29 | 0.4 | 0 |

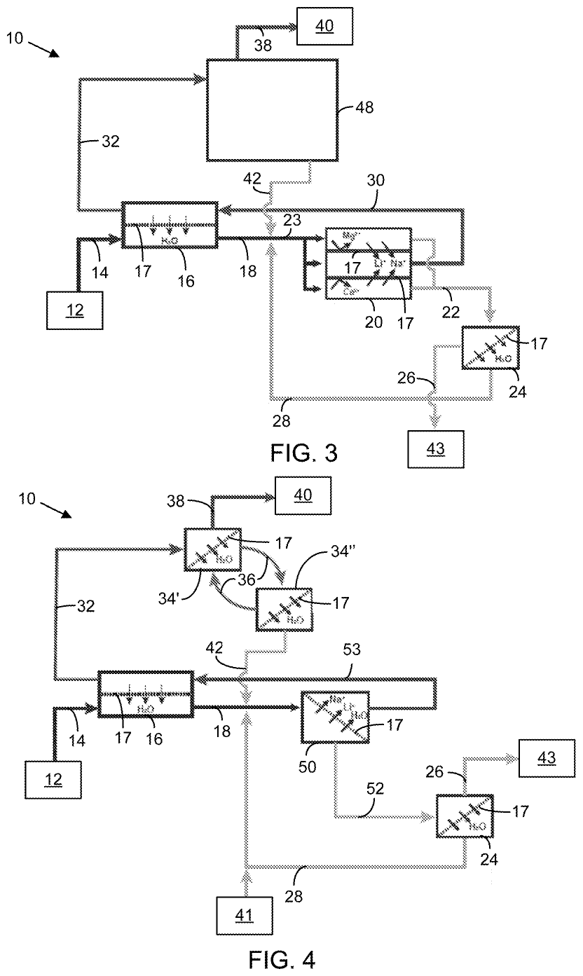

Additional configurations that can achieve the same or similar advantages are shown in FIGS. 3 (system two), 4 (system three), 5 (system four), 6 (system five), and 7 (system six).

In system two, shown in FIG. 3, the OARO modules 34′ and 34″ of FIG. 1 are replaced with a multi-effect distillation, mechanical vapor compression, or multi-stage-flash distillation system 48. Comparing multi-effect distillation with OARO, multi-effect distillation is a thermally driven method, while OARO is driven by electricity. MED allows for the usage of waste heat that may be unsuitable for further power generation in a power plant.

In system three, shown in FIG. 4, the valency-selective electrodialysis module 20 of FIG. 1 is replaced with a nanofiltration module 50.

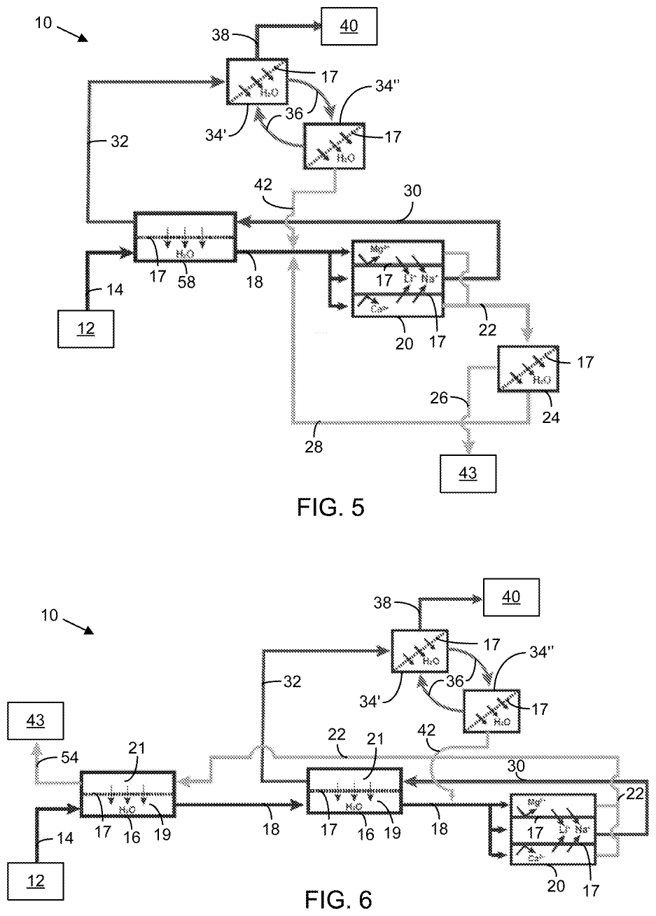

In system four, shown in FIG. 5, the forward-osmosis module 16 of FIG. 1 is replaced with a pressure-retarded osmosis module 58. If suitable membranes are available, pressure-retarded osmosis can harness part of the available free energy as electricity, lowering the net cost of desalination in the osmotically assisted reverse osmosis stages (see the top half of FIG. 1)

In system five, shown in FIG. 6, a pair of the forward osmosis (FO) modules 16 are provided in series, where in the feed stream will pass through both FO modules 16 sequentially en route from the source reservoir 12 to the valency-selective electrodialysis module 20 to further dilute the feed stream before it enters the valency-selective electrodialysis module 20, and wherein the multivalent-rich stream from the valency-selective electrodialysis module is fed via conduit 22 through the second side 21 of the first (left-most) FO module 16 and then through conduit 54 to reservoir 43.

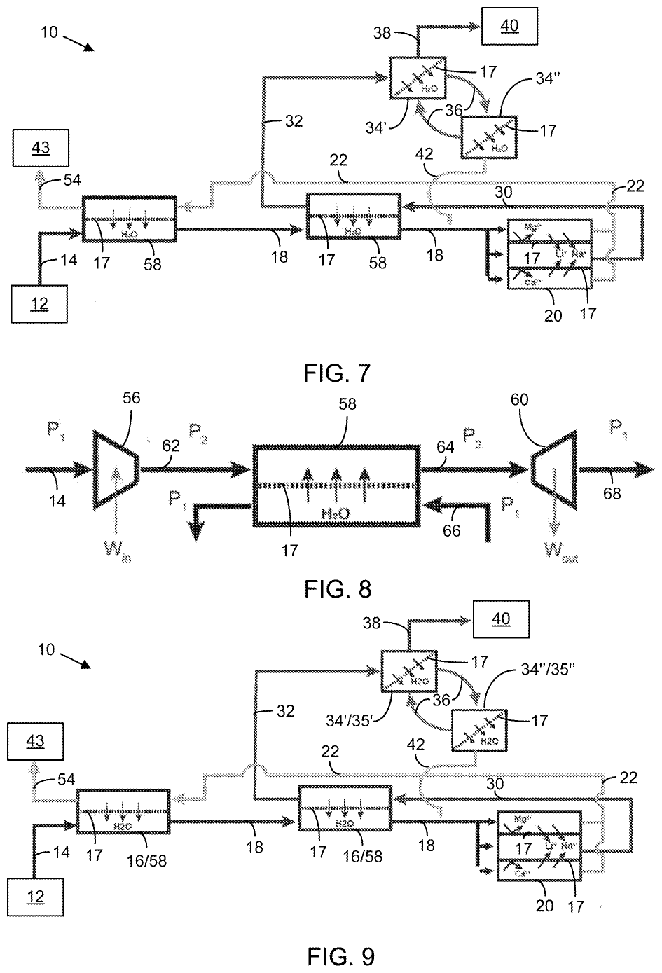

System six, shown in FIG. 7, is similar to system four (shown in FIG. 5), except a pair of pressure-retarded osmosis modules 58 are used in series in the system of FIG. 7, similar to how the pair of FO modules 16 were used in system five, as shown in FIG. 6.

A generalized system 10 is illustrated in FIG. 9, showing the interchangeability of using either a forward osmosis module 16 or a pressure-retarded osmosis module 58 to dilute the mixed, aqueous brine stream from the mixed-feed source 12 as well as the interchangeability of using a valency-selective electrodialysis module 20 or a nanofiltration module 50 in systems described herein that include either of these modules, such as in systems five and six, shown respectively in FIGS. 6 and 7. Further still, in FIG. 9 the sequence of modules can be either osmotically assisted reverse osmosis modules 34′ and 34″ or low-salt-rejection reverse osmosis (LSRRO) modules 35′ and 35″, as is the case in various other systems described herein.

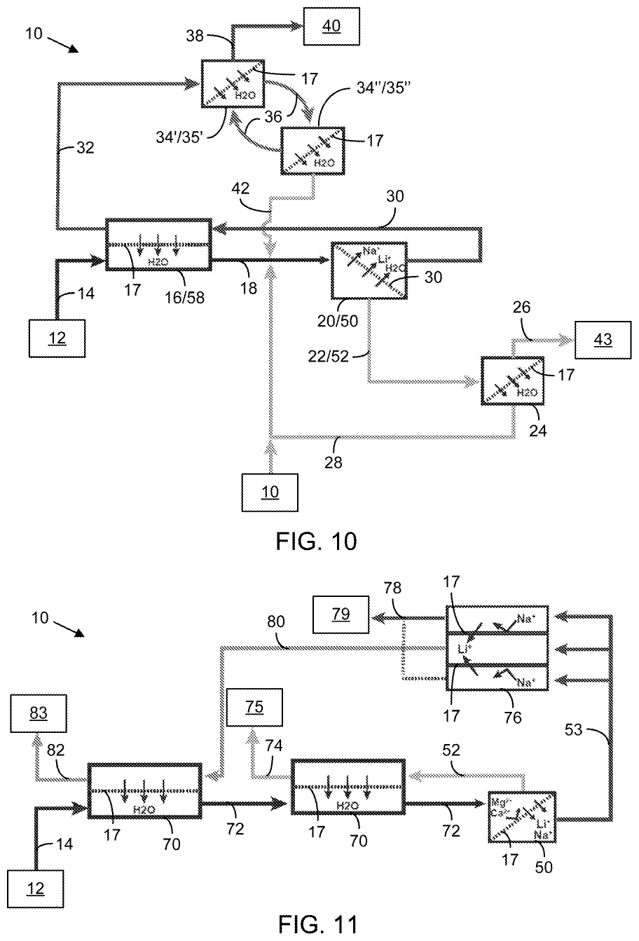

Another generalized system 10, illustrated in FIG. 10, shows the interchangeability of using either a forward osmosis module 16 or a pressure-retarded osmosis module 58, the interchangeability of using the multivalent-selective electrodialysis module 20 or the nanofiltration module 50, and the interchangeability of using a sequence of either low-salt-rejection reverse osmosis (LSRRO) modules 35′ and 35″ or osmotically assisted reverse osmosis modules 34′ and 34′ in systems described herein, such as in systems three and four, shown respectively in FIGS. 4 and 5.

These methods and systems can also be used to extract lithium ions (Li⁺) from a mixed feed stream. FIG. 11 schematically illustrates a system 10 for lithium extraction, including a sequence of counterflow reverse-osmosis (CFRO) modules 70 joined by conduit 72 for flow into a nanofiltration module 50, which separates the feed from the second CFRO module 70 into (a) a multivalent-rich stream, which flows through conduit 52, then through the second side of the second CFRO module 70, then through conduit 74 to reservoir 75 and (b) a diluted monovalent-rich stream, which flows through conduit 53. Conduit 53 branches to provide respective paths for the diluted monovalent-rich stream to enter inner and outer passages between membranes in the lithium-selective electrodialysis (LSED) module 76, which produces an outer concentrated sodium-rich stream (passing through conduit 78 to reservoir 79) and a diluted lithium-rich stream (passing through conduit 80 and then through the second side of a counterflow reverse osmosis (CFRO) module 70 and finally thorough conduit 82 to a reservoir 83.

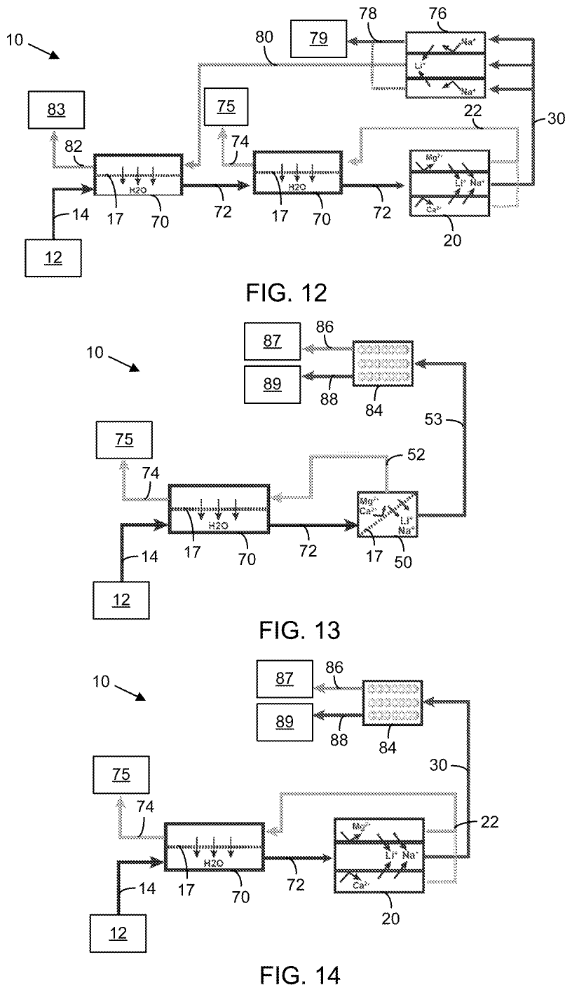

The system 10 of FIG. 12 is similar to that of FIG. 11, except the valency-selective-ion-separation module is a monovalent-selective electrodialysis (MSED) module 20 instead of a nanofiltration module 50.

Another system 10 for lithium extraction is illustrated in FIG. 13. This system uses a single counterflow reverse-osmosis (CFRO) module 70 which connects via conduit 72 to a nanofiltration module 50 that separates the stream into a multivalent-rich stream and a monovalent-rich stream. The multivalent-rich stream is directed from the retentate side upstream from the membrane 17 in the nanofiltration module 50 through conduit 52 and then through the second side of the CFRO module 70. Meanwhile, the monovalent-rich stream is directed from the permeate side downstream from the membrane 17 in the nanofiltration module 50 through conduit 53 into an ion-exchange resin 84 that separates the diluted monovalent-rich stream from the nanofiltration module 50 into a concentrated lithium-rich stream extracted via conduit 86 to reservoir 87 and a concentrated sodium-rich stream extracted via conduit 88 to reservoir 89. The ion-exchange resin is usually a polymer or ceramic that has fixed charged groups attached to it. When a Li-rich stream is passed over its surface, due to its high charge density and small ionic radii, Li⁺ ions will selectively adsorb onto these charged surfaces of the ion-exchange resins. In a recovery stage, a secondary solvent (which can be water, acid or other chemicals) is passed over the lithium-adsorbed surface, inducing the desorption of lithium into the secondary stream. The recharged ion-exchanged resin can be reused following lithium desorption.

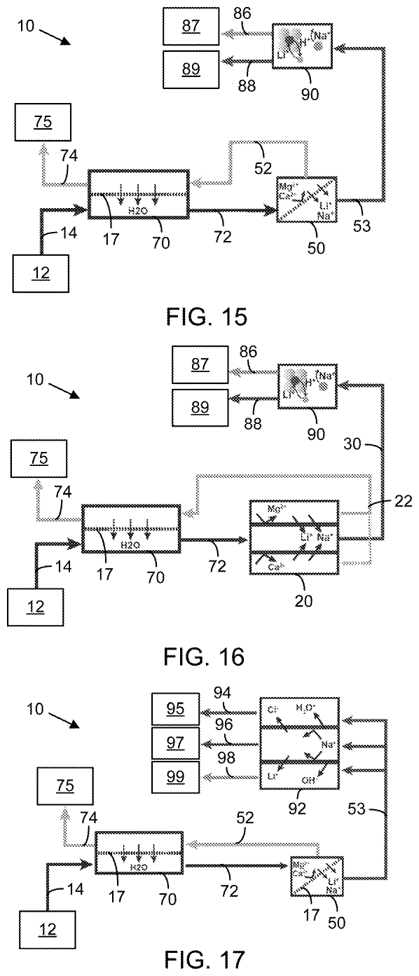

The system 10 of FIG. 14 is similar to that of FIG. 13, though the valency-selective-ion-separation module is a valency-selective electrodialysis module 20 instead of the nanofiltration module used in the system 10 of FIG. 13. The system 10 of FIG. 15 is similar to the system 10 of FIG. 13, except it includes an ion sieve 90 in place of the ion-exchange resin 84. The ion sieve 90 is usually a ceramic or polymeric material with ion-sized holes or channel. In this application, these holes/channels are tuned to be close to the ionic radii of the lithium ion. This allows lithium to selectively pass through while other ions are rejected. Another system 10 using an ion sieve 90 is shown in FIG. 16; this system 10 is otherwise similar to that of FIG. 14.

Another system 10 for lithium extraction, shown in FIG. 17, is similar to the system 10 of FIGS. 13 and 15, except it includes a bipolar membrane electrodialysis module 92 in place of the ion-exchange resin 84/ion sieve 90 of FIGS. 13 and 15.

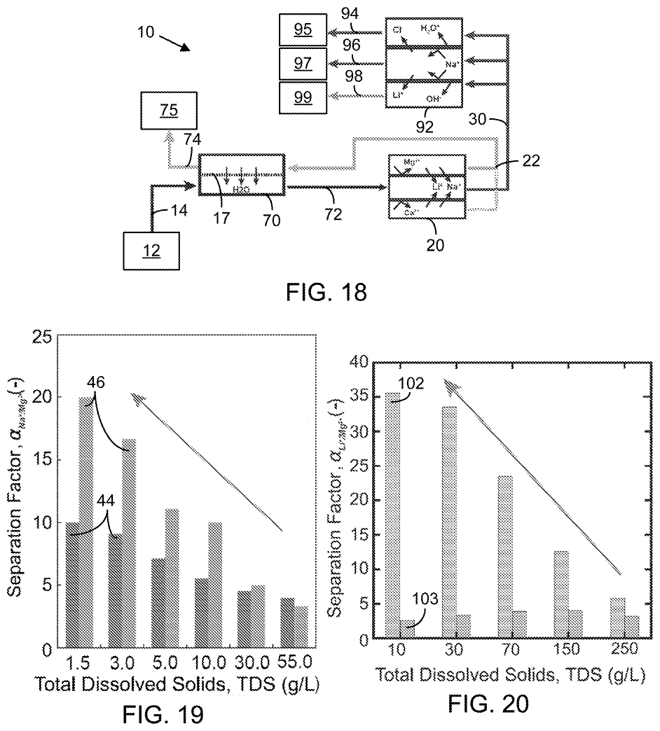

Likewise, the system 10 of FIG. 18, is similar to the system 10 of FIGS. 14 and 16, except it includes a bipolar membrane electrodialysis module 92 in place of the ion-exchange resin 84/ion sieve 90 of FIGS. 14 and 16. Conduits 94, 96, 98 respectively extract the flow of a concentrated HCL solution, a sodium-rich solution, and a LiOH base solution into respective reservoirs 95, 97, and 99.

The separation factor exhibited by the two MSED membrane filters (a NEOSEPTA membrane 44 from Astom Corp. of Tokyo, Japan, and a FUJIFILM membrane 46 from Fujifilm Holdings Corp. of Tokyo, Japan) described with respect to FIG. 2 at various total dissolved solids (TDS) contents in the solution fed to the to the valency-selective electrodialysis module are plotted in FIG. 19, wherein the separation efficiency (i.e., the selectivity of the membranes) can be seen to increase for both members with increasing water recovery (lower dissolved solids). The FUJIFILM membrane 46 exhibited greater selectivity with purer solutions, while the NEOSEPTA filter 44 maintained a more even performance across the range of concentrations and appears to start to perform slightly better around 50 g/L TDS and higher.

The separation factor exhibited by a nanofiltration module (e.g., with a NF-270 membrane from DuPont) for feed solutions that are neutral (pH=7) 103 and highly acidic (pH=2) 102 are plotted in FIG. 20, where the membrane selectivity of the membrane with the highly acidic solution 102 improves with increasing water recovery, while the membrane selectivity at a neutral pH 103 remains fairly consistent across the range of TDS concentrations.

In describing embodiments, herein, specific terminology is used for the sake of clarity. For the purpose of description, specific terms are intended to at least include technical and functional equivalents that operate in a similar manner to accomplish a similar result. Additionally, in some instances where a particular embodiment includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments, those parameters or values can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof or within a range of the specified parameter up to or down to any of the variations specified above (e.g., for a specified parameter of 100 and a variation of 1/100^{th}, the value of the parameter may be in a range from 0.99 to 1.01), unless otherwise specified. Further still, where methods are recited and where steps/stages are recited in a particular order—with or without sequenced prefacing characters added for ease of reference—the steps/stages are not to be interpreted as being temporally limited to the order in which they are recited unless otherwise specified or implied by the terms and phrasing.

Additional examples consistent with the present teachings are set out in the following numbered clauses:
1. A method for harnessing targeted metal ions from brines, comprising:
   feeding a mixed, aqueous, brine stream comprising targeted metal ions and other dissolved ions through a water-recovery module on a first side of a first membrane;
   in the water-recovery module, passing water from a monovalent-ion-rich stream on a second side of the first membrane through the first membrane into the mixed, aqueous, brine stream on the first side of the first membrane to produce a diluted, mixed, aqueous, brine stream;
   passing the diluted, mixed, aqueous, brine stream through a valency-selective ion-separation module to produce the monovalent-rich stream, and a multivalent-ion-rich stream, one of which includes a concentration of the targeted metal ions.
2. The method of clause 1, wherein the water-recovery module is selected from a forward osmosis module, a direct-dilution module, a pressure-retarded osmosis module, a reverse electrodialysis module, a counterflow reverse osmosis module, and an osmotically assisted reverse osmosis.
3. The method of clause 1 or 2, wherein the valency-selective ion-separation module is selected from a monovalent-selective electrodialysis module and a monovalent-selective nanofiltration module.
4. The method of any of clauses 1-3, wherein the monovalent-rich stream is circulated from the valency-selective ion-separation module through the water-recovery module on the first side of the first membrane.
5. The method of any of clauses 1-4, wherein the monovalent-rich stream is passed through a secondary concentration module selected from an osmotically-assisted reverse osmosis module, a high-pressure reverse osmosis module, a cascading osmotically mediated reverse osmosis module, a counterflow reverse osmosis module, a multiple effect distillation module, a mechanical vapor compression module, a solvent-extraction module, and a low-salt-rejection reverse osmosis in the extraction of monovalent ions therefrom.
6. The method of any of clauses 1-5, further comprising passing the multivalent-rich stream through a reverse osmosis module to extract purified water from the multivalent-rich stream.
7. The method of any of clauses 1-6, wherein the targeted metal ions comprise lithium ions.
8. The method of clause 7, wherein the mixed, aqueous, brine stream further comprises at least the following additional dissolved ions: Mg²⁺, Ca²⁺, Na⁺.
9. The method of clause 7 or 8, further comprising extracting lithium from the monovalent-rich stream.
10. The method of any of clauses 1-9, wherein the mixed, aqueous brine stream is selected from a brine from a spodumene deposit, a salt-lake brine, a geothermal leachate, a continental brine, a textile-mill waste, a brine from extraction of at least one of oil and gas, and a mining brine.
11. The method of any of clauses 1-10, wherein the monovalent-rich stream flows in counterflow to the mixed, aqueous, brine stream in the water-recovery module.
12. A system for harnessing targeted metal ions from brines, comprising:
   a water-recovery module including a first membrane that divides the water-recovery module into a first side and a second side, wherein the water-recovery module is configured to receive a mixed, aqueous, brine stream comprising targeted metal ions and other dissolved ions on the first side of the first membrane and a monovalent-rich stream on the second side of the first membrane, and wherein the first membrane is structured and configured to pass water from the monovalent-rich stream into the mixed, aqueous, brine stream on the first side to produce a diluted, mixed aqueous brine stream; and
   a valency-selective ion-separation module configured to receive the diluted, mixed aqueous brine stream and to produce the monovalent-ion-rich stream and a multivalent-rich stream therefrom.
13. The system of clause 12, wherein the water-recovery module is selected from a forward osmosis module and a pressure-retarded osmosis module.
14. The system of clause 12 or 13, wherein the valency-selective ion-separation module is selected from a monovalent-selective electrodialysis module and a monovalent-selective nanofiltration module.
15. The system of any of clauses 12-14, further comprising a separation apparatus configured to receive the monovalent-rich stream to extract the targeted metal ions therefrom.
16. The system of clause 15, wherein the separation apparatus comprises a module selected from an osmotically assisted reverse osmosis module, a multiple effect distillation module, a mechanical vapor compression module, and a solvent-extraction module.
17. The system of any of clauses 12-16, wherein the targeted monovalent ions comprise lithium ions.
18. The system of any of clauses 12-17, further comprising a module selected from a standalone reverse osmosis, a high-pressure reverse osmosis module, an osmotically-assisted reverse osmosis module, a low-salt-rejection reverse osmosis module, an osmotically-enhanced reverse osmosis module, a cascading osmotically mediated reverse osmosis module, a counter-flow reverse-osmosis module, a batch reverse-osmosis module, or a semi-batch reverse-osmosis module configured to receive the multivalent-rich stream and to extract purified water therefrom.
19. The system of any of clauses 12-18, wherein the water-recovery module is configured to pass the monovalent-rich stream in counterflow to the mixed, aqueous, brine stream.
20. A method for harnessing targeted metal ions from brines, comprising:
   directly diluting a mixed, aqueous, brine stream comprising targeted metal ions and other dissolved ions to produce a diluted, mixed, aqueous, brine stream; and passing the diluted, mixed, aqueous, brine stream through a valency-selective ion-separation module to produce the monovalent-rich stream, and a multivalent-rich stream, one of which includes the targeted metal ions.

While this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety for all purposes; and all appropriate combinations of embodiments, features, characterizations, and methods from these references and the present disclosure may be included in embodiments of this invention. Still further, the components and steps identified in the Background section are integral to this disclosure and can be used in conjunction with or substituted for components and steps described elsewhere in the disclosure within the scope of the invention.

### PARTS LIST

10: system for harnessing targeted metal ions from brines
12: source of mixed feed stream
14: conduit into FO module for mixed feed stream
16: forward osmosis (FO) module
17: membrane
18: conduit from FO module for diluted mixed stream
19: first side of FO module
20: valency-selective electrodialysis module
21: second side of FO module
22: conduit for multivalent-rich stream from valency-selective electrodialysis module
24: reverse osmosis (RO) module
26: conduit for multivalent-rich stream from RO module
28: conduit for potable water from RO module
30: conduit for monovalent-rich stream from valency-selective electrodialysis module
32: conduit for monovalent-rich stream from FO module
34′ and 34″: osmotically assisted RO (OARO) modules
35′ and 35″: low-salt-rejection RO (LSRRO) modules
36: fluid exchange conduits between OARO modules
38: conduit for monovalent-rich stream from OARO modules
40: reservoir for monovalent brine output vessel
41: source for portable water
42: conduit for potable water from OARO modules
43: reservoir for multivalent-rich stream
44: FIG. 2 plot: perselectivity [Mg/Na]—Neosepta
46: FIG. 2 plot: perselectivity [Mg/Na]—Fujifilm
48: multi-effect distillation, mechanical vapor compression (MED MVC), or multi-stage flash evaporator
50: nanofiltration module
52: conduit for multivalent-rich stream from nanofiltration module
53: conduit for diluted monovalent-rich stream from nanofiltration module
54: conduit for multivalent-rich stream from FO module
56: pump
58: pressure-retarded osmosis (PRO) module
60: power-generating turbine
62: conduit for pressurized feed
64: conduit for diluted feed/brine stream
66: conduit for dilute stream
68: conduit for de-pressurized feed/brine stream
70: counterflow reverse osmosis (CFRO) module
72: conduit from CFRO module
74: conduit for concentrated multivalent-rich stream from CFRO module
75: reservoir for multivalent-rich stream from CFRO module
76: lithium-selective electrodialysis (LSED) module
78: conduit for concentrated sodium-rich stream from LSED module
79: reservoir for concentrated sodium-rich stream from LSED module
80: conduit for diluted lithium-rich stream from LSED module
82: conduit for concentrated lithium-rich stream from CFRO module
83: reservoir for concentrated lithium-rich stream from CFRO module
84: ion-exchange resin
86: conduit for concentrated lithium-rich stream from ion-exchange resin
87: reservoir for concentrated lithium-rich stream from ion-exchange resin
88: conduit for concentrated sodium-rich stream from ion-exchange resin
90: ion sieve
92: bipolar membrane electrodialysis (BPMED) module
94: conduit for concentrated hydrochloric (HCl) acid from BPMED module
95: reservoir for concentrated hydrochloric (HCl) acid from BPMED module
96: conduit for concentrated sodium-rich stream from BPMED module
97: reservoir for concentrated sodium-rich stream from BPMED module
98: conduit for LiOH base from BPMED module
99: reservoir for LiOH base from BPMED module
102: FIG. 20 plot: separation factor for a feed with a pH of 2
103: FIG. 20 plot: separation factor for a feed with a pH of 7

1. A method for harnessing targeted metal ions from brines, comprising:
feeding a mixed, aqueous, brine stream comprising targeted metal ions and other dissolved ions through a water-recovery module on a first side of a first membrane;
in the water-recovery module, passing water from a monovalent-ion-rich stream on a second side of the first membrane through the first membrane into the mixed, aqueous, brine stream on the first side of the first membrane to produce a diluted, mixed, aqueous, brine stream;
passing the diluted, mixed, aqueous, brine stream through a valency-selective ion-separation module to produce the monovalent-rich stream, and a multivalent-ion-rich stream, one of which includes a concentration of the targeted metal ions; and
passing the monovalent-rich or multivalent-rich stream including the concentration of the targeted metal ions through an intravalency-selective separation module in which the targeted metal ions are separated from other ions of the same valency.

2. The method of claim 1, wherein the water-recovery module is selected from a forward osmosis module, a direct-dilution module, a pressure-retarded osmosis module, a reverse electrodialysis module, a counterflow reverse osmosis module, and an osmotically assisted reverse osmosis.

3. The method of claim 1, wherein the valency-selective ion-separation module is selected from a monovalent-selective electrodialysis module and a monovalent-selective nanofiltration module.

4-6. (canceled)

7. The method of claim 1, wherein the targeted metal ions comprise lithium ions.

8. The method of claim 7, wherein the mixed, aqueous, brine stream further comprises at least the following additional dissolved ions: Mg²⁺, C^{a2+}, Na⁺.

9. (canceled)

10. The method of claim 1, wherein the mixed, aqueous brine stream is selected from a brine from a spodumene deposit, a salt-lake brine, a geothermal leachate, a continental brine, a textile-mill waste, a brine from extraction of at least one of oil and gas, and a mining brine.

11. (canceled)

12. A system for harnessing targeted metal ions from brines, comprising:
a water-recovery module including a first membrane that divides the water-recovery module into a first side and a second side, wherein the water-recovery module is configured to receive a mixed, aqueous, brine stream comprising targeted metal ions and other dissolved ions on the first side of the first membrane and a monovalent-rich stream on the second side of the first membrane, and wherein the first membrane is structured and configured to pass water from the monovalent-rich stream into the mixed, aqueous, brine stream on the first side to produce a diluted, mixed aqueous brine stream; and
a valency-selective ion-separation module configured to receive the diluted, mixed aqueous brine stream and to produce the monovalent-ion-rich stream and a multivalent-rich stream therefrom; and
an intra-valency-selective separation module configured to receive either the monovalent-rich stream or the multivalent-rich stream and to separate and extract targeted metal ions from other ions of the same valency.

13. The system of claim 12, wherein the water-recovery module is selected from a forward osmosis module and a pressure-retarded osmosis module.

14. The system of claim 12, wherein the valency-selective ion-separation module is selected from a monovalent-selective electrodialysis module and a monovalent-selective nanofiltration module.

15. The system of claim 12, wherein the intra-valency-selective separation module is configured to receive the monovalent-rich stream and to separate and extract the targeted metal ions therefrom.

16. (canceled)

17. The system of claim 15, wherein the targeted monovalent ions comprise lithium ions.

18-20. (canceled)

21. The method of claim 1, wherein the monovalent-rich stream includes the concentration of the targeted metal ions and is passed through the intra-valency-selective separation module, which separates the targeted metal ions from other monovalent ions.

22. The method of claim 7, wherein the lithium ions are in the form of LiOH.

23. The method of claim 22, wherein the intra-valency-selective separation module is a bipolar membrane electrodialysis module.

24. The method of claim 21, wherein the intra-valency-selective separation module comprises an ion-selective electrodialysis module, an ion-exchange resin, or an ion sieve.

25. The method of claim 24, wherein the ion-selective electrodialysis module is a lithium-selective electrodialysis module.

26. The system of claim 12, wherein the intra-valency-selective separation module is configured to receive the monovalent-rich stream and to separate the targeted metal ions from other monovalent ions.

27. The system of 26, wherein the intra-valency-selective separation module is a bipolar membrane electrodialysis module.

28. The system of 26, wherein the intra-valency-selective separation module comprises an ion-selective electrodialysis module, an ion-exchange resin, or an ion sieve.

29. The system of claim 28, wherein the ion-selective electrodialysis module is a lithium-selective electrodialysis module.
